(19) United States
(12) Patent Application Publication
(10) Pub. No.: US 2025/0069498 A1
(43) Pub. Date: Feb. 27, 2025

(54) APPARATUS FOR FORECASTING TRAFFIC FLOW OF ROAD AND METHOD THEREOF

(71) Applicants: HYUNDAI MOTOR COMPANY, Seoul (KR); Kia Corporation, Seoul (KR)

(72) Inventor: Nam Hyuk KIM, Seoul (KR)

(21) Appl. No.: 18/434,774

(22) Filed: Feb. 6, 2024

(30) Foreign Application Priority Data
Aug. 25, 2023 (KR) 10-2023-0112254

(51) Int. Cl. G08G 1/01

(52) U.S. Cl. CPC G08G 1/0129; G08G 1/0133

(57) ABSTRACT

An apparatus for forecasting a traffic flow of a road includes storage that stores traffic information by date for a preset time period, and a controller that divides dates into a specified number of classes, determines a target class corresponding to a target date among the classes, and forecasts a traffic flow of the target date based on the traffic information by date included in the target class.

### CROSS-REFERENCE TO RELATED APPLICATION

This application claims the benefit of priority to Korean Patent Application No. 10-2023-0112254, filed in the Korean Intellectual Property Office on Aug. 25, 2023, the entire contents of which are incorporated herein by reference.

### TECHNICAL FIELD

The present disclosure relates to a technology for forecasting traffic flow of a road based on an artificial neural network model.

### BACKGROUND

In general, an artificial neural network (ANN), which is a field of artificial intelligence, is an algorithm for allowing a machine to learn made by simulating a human neural structure. Recently, it has been applied to image recognition, speech recognition, natural language processing, and the like, and has shown excellent effects. An artificial neural network includes an input layer that receives an input, a hidden layer that actually learns, and an output layer that returns the result of an operation. The artificial neural network including the plurality of hidden layers is called a deep neural network (DNN), which is also a kind of artificial neural network.

An artificial neural network allows a computer to learn by itself based on data. When trying to solve a problem using an artificial neural network, it may be necessary to prepare a suitable artificial neural network model and data to be analyzed. An artificial neural network model to solve a problem is trained based on data. Before training the model, it may be necessary to first divide the data into two types. That is, the data should be divided into a train dataset and a validation dataset. The train dataset is used to train the model, and the validation dataset is used to verify the performance of the model.

There are various reasons for validating an artificial neural network model. An artificial neural network developer tunes the model by modifying the hyper parameters of a model based on the verification result of the model. In addition, the model verification is performed to select a suitable model from various models. The reason why the model verification may be necessary is explained in more detail as follows.

The first is to predict accuracy. As a result, the purpose of artificial neural networks is to achieve good performance on out-of-sample data not used for training. Therefore, after creating the model, it is essential to check how well the model will perform on out-of-sample data. However, because the model should not be verified using the train dataset, the accuracy of the model should be measured using the validation dataset separated from the train dataset.

The second is to increase the performance of the model by tuning the model. For example, it is possible to prevent overfitting. Overfitting means that the model is over-trained on the train dataset. For example, when the training accuracy is high but the validation accuracy is low, the occurrence of overfitting may be suspected. In addition, it may be understood in more detail through training loss and validation loss. When overfitting occurs, it may be necessary to prevent overfitting to increase the validation accuracy. It is possible to prevent overfitting by using a scheme such as regularization or dropout.

Meanwhile, a conventional technology for predicting a traffic flow of a road determines the day of the week for the date to be predicted, collects the traffic speed corresponding to the same past day of the week as the day of the week, and predicts the traffic flow on the date to be predicted based on the traffic speed.

Because the conventional technology simply predicts the traffic flow on the date to be predicted based on the traffic speed of the same day of the past week, it is difficult to predict the traffic flow with high accuracy and also predict various traffic situations.

### SUMMARY

An aspect of the present disclosure provides an apparatus for forecasting a traffic flow of a road and a method thereof that may predict the traffic flow of the target date with high accuracy by storing traffic information by date for a preset time period, dividing dates into a specified number of classes, determining a target class corresponding to a target date among the classes, and forecasting a traffic flow of the target date based on the traffic information by date included in the target class.

Another aspect of the present disclosure provides an apparatus for forecasting a traffic flow of a road and a method thereof that can predict the traffic flow of the target date with high accuracy by storing traffic information by date for a preset time period, dividing dates into a specified number of classes, determining a target class corresponding to a target date among the classes, and forecasting a future traffic flow of the target date based on the traffic information by date included in the target class and the current traffic information of the target date.

Still another aspect of the present disclosure provides an apparatus for forecasting a traffic flow of a road and a method thereof that can predict the afternoon traffic flow of the target date with high accuracy by storing morning traffic information and afternoon traffic information by date during the preset time period, dividing dates into a specified number of classes, determining a target class corresponding to a target date among the classes, and forecasting the afternoon traffic flow of the target date based on the morning traffic information by date included in the target class and the morning traffic information of the target date.

Still another aspect of the present disclosure provides an apparatus for forecasting a traffic flow of a road and a method thereof that can predict the afternoon traffic flow of the target date with high accuracy by storing morning traffic information and afternoon traffic information by date during the preset time period, dividing dates into a specified number of classes, determining a target class corresponding to a target date among the classes, determining a representative date most similar to the morning traffic information of the target date among the morning traffic information by date included in the target class, and forecasting an afternoon traffic flow of the target date based on afternoon traffic information of the representative date.

The technical problems to be solved by the present disclosure are not limited to the aforementioned problems, and any other technical problems not mentioned herein will be clearly understood from the following description by those skilled in the art to which the present disclosure pertains. Also, it may be easily understood that the objects and advantages of the present disclosure may be realized by the units and combinations thereof recited in the claims.

According to an aspect of the present disclosure, an apparatus for forecasting a traffic flow of a road includes storage that stores traffic information by date for a preset time period, and a controller that divides dates into a specified number of classes, determines a target class corresponding to a target date among the classes, and forecasts a traffic flow of the target date based on the traffic information by date included in the target class.

In some implementations, the controller may obtain a traffic information of the target date from a traffic information server; and forecast a future traffic flow of the target date based on the traffic information by date included in the target class and the traffic information of the target date.

In some implementations, the storage may store morning traffic information and afternoon traffic information by date during the preset time period.

In some implementations, the controller may obtain morning traffic information of the target date from a traffic information server, and forecast an afternoon traffic flow of the target date based on the morning traffic information by date included in the target class and the morning traffic information of the target date.

In some implementations, the controller may obtain morning traffic information of the target date from a traffic information server, determine a representative date most similar to the morning traffic information of the target date among the morning traffic information by date included in the target class, and forecast an afternoon traffic flow of the target date based on afternoon traffic information of the representative date.

In some implementations, the controller may determine the representative date most similar to the morning traffic information of the target date among the morning traffic information by date included in the target class based on a contrastive learning model.

In some implementations, the traffic information may include at least one of a traffic volume on each road, a traffic speed on each road, a travel time on each road, or a combination thereof.

In some implementations, the class may include at least one of an one-day public holiday that is not a weekend, a day before the one-day public holiday that is not a weekend, a day after the one-day public holiday that is not a weekend, a day before two consecutive public holidays, a first day of two consecutive public holidays, a last day of two consecutive days of public holidays, a day after two consecutive days of public holidays, a day before five consecutive days of public holidays, a first day of five consecutive days of public holidays, a last day of five consecutive days of public holidays, a day after five consecutive days of public holidays, a weekday, or a combination thereof.

According to another aspect of the present disclosure, a method of forecasting traffic flow of a road includes storing, by storage, traffic information by date for a preset time period, dividing, by a controller, dates into a specified number of classes, determining, by the controller, a target class corresponding to a target date among the classes, and forecasting, by the controller, a traffic flow of the target date based on the traffic information by date included in the target class.

In some implementations, the forecasting of the traffic flow of the target date may include obtaining, by the controller, a traffic information of the target date from a traffic information server, and forecasting, by the controller, a future traffic flow of the target date based on the traffic information by date included in the target class and the traffic information of the target date.

In some implementations, the storing of the traffic information by date may include storing, by the storage, morning traffic information and afternoon traffic information by date during the preset time period.

In some implementations, the forecasting of the traffic flow of the target date may include obtaining, by the controller, morning traffic information of the target date from a traffic information server, and forecasting, by the controller, an afternoon traffic flow of the target date based on the morning traffic information by date included in the target class and the morning traffic information of the target date.

In some implementations, the forecasting of the traffic flow of the target date may include obtaining, by the controller, morning traffic information of the target date from a traffic information server, determining, by the controller, a representative date most similar to the morning traffic information of the target date among the morning traffic information by date included in the target class, and forecasting, by the controller, an afternoon traffic flow of the target date based on afternoon traffic information of the representative date.

In some implementations, the determining of the representative date most similar to the morning traffic information of the target date may include determining, by the controller, the representative date most similar to the morning traffic information of the target date among the morning traffic information by date included in the target class based on a contrastive learning model.

### BRIEF DESCRIPTION OF THE DRAWINGS

FIG. 1 is a block diagram illustrating an example of an apparatus for forecasting a traffic flow of a road.

FIG. 2 is a diagram illustrating an example of a contrastive learning model provided in an apparatus for forecasting a traffic flow of a road.

FIG. 3 is a diagram illustrating an example of a learning process of a contrastive learning model provided in an apparatus for forecasting a traffic flow of a road.

FIG. 4 is a diagram illustrating an example of a similarity prediction process of a contrastive learning model provided in an apparatus for forecasting a traffic flow of a road.

FIG. 5 is a diagram illustrating an example of traffic information by date of a first class stored in storage provided in an apparatus for forecasting a traffic flow of a road.

FIG. 6 is a diagram illustrating an example of traffic information by date of the second class stored in the storage provided in an apparatus for forecasting a traffic flow of a road.

FIG. 7 is a diagram illustrating an example of traffic information by date of the third class stored in the storage provided in an apparatus for forecasting a traffic flow of a road.

FIG. 8 is a diagram illustrating an example of traffic information by date of the fourth class stored in the storage provided in an apparatus for forecasting a traffic flow of a road.

FIG. 9 is a flowchart illustrating an exemplary method of forecasting a traffic flow of a road.

FIG. 10 is a block diagram illustrating an example of a computing system for executing a method of forecasting a traffic flow of a road.

### DETAILED DESCRIPTION

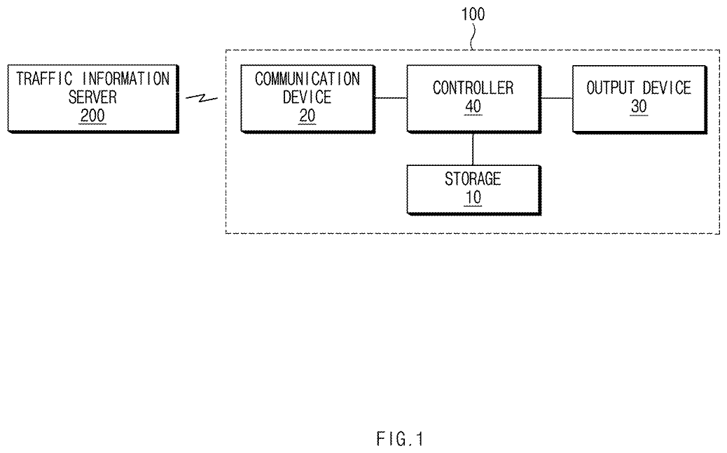

FIG. 1 is a block diagram illustrating an apparatus for forecasting a traffic flow of a road.

As shown in FIG. 1, an apparatus 100 for forecasting a traffic flow of a road may include storage 10, a communication device 20, an output device 30, and a controller 40. In this case, depending on a scheme of implementing the apparatus 100 for forecasting a traffic flow of a road, components may be combined with each other to be implemented as one, or some components may be omitted.

Regarding each component, first, the storage 10 may store traffic information by date for a preset time period.

The storage 10 may store various logic, algorithms and programs required in the processes of dividing dates into a specified number of classes, determining a target class corresponding to a target date among the classes, and forecasting a traffic flow of the target date based on the traffic information by date included in the target class.

The storage 10 may various logic, algorithms and programs required in the processes of dividing dates into a specified number of classes, determining a target class corresponding to a target date among the classes, and forecasting a future traffic flow of the target date based on the traffic information by date included in the target class and the current traffic information of the target date.

The storage 10 may store morning traffic information and afternoon traffic information by date during the preset time period.

The storage 10 may various logic, algorithms and programs required in the processes of dividing dates into a specified number of classes, determining a target class corresponding to a target date among the classes, and forecasting the afternoon traffic flow of the target date based on the morning traffic information by date included in the target class and the morning traffic information of the target date.

The storage 10 may various logic, algorithms and programs required in the processes of dividing dates into a specified number of classes, determining a target class corresponding to a target date among the classes, determining a representative date most similar to the morning traffic information of the target date among the morning traffic information by date included in the target class, and forecasting an afternoon traffic flow of the target date based on afternoon traffic information of the representative date.

The communication device 20, which is a module for providing a communication interface with a traffic information server 200, may include at least one of a mobile communication module, a wireless module, and Internet a short-range communication module.

The mobile communication module may communicate with the traffic information server 200 through a mobile communication network constructed according to a technical standard or communication scheme for mobile communication (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTEA), and the like).

The wireless Internet module, which is a module for wireless Internet access, may communicate with the traffic information server 200 through wireless LAN (WLAN), wireless-fidelity (Wi-Fi), Wi-Fi direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and the like.

The short-range communication module may support short-range communication with the traffic information server 200 by using at least one of Bluetooth™, radio frequency identification (RFID), infrared data association (IrDA), ultra wideband (UWB), ZigBee, near field communication (NFC), and wireless universal serial bus (USB) technology.

The output device 30 may output the traffic flow of the target date predicted by the controller 40 in video or audio. To this end, the output device 30 may include a display module and an audio output module.

Such a display module may display (output) information processed in a vehicle multimedia system. For example, in a navigation mode, a user interface (UI) or graphic user interface (GUI) related to driving, such as a map related to a current location, destination, route, and the like, speed, direction, distance indication, and the like may be displayed. In a black box mode or a photographing mode, the photographed image, UI, or GUI may be displayed.

In addition, the display module may include at least one of a liquid crystal display (LCD), a thin film transistor-liquid crystal display (TFT LCD), an organic light-emitting diode (OLED), a flexible display, and a 3D display.

When the display module and the touch sensor form a mutual layer structure (hereinafter, referred to as a ‘touch screen’), the display module may be used as an input device in addition to an output device.

The audio output module may output audio data in a multimedia file playback mode or a broadcast reception mode, or output audio data stored in a memory. The audio output module may output audio signals related to functions (e.g., a warning sound, a notification sound, a route guidance voice, and the like) performed in a vehicle multimedia system. For example, the audio output module may include a receiver, a speaker, a buzzer, and the like.

The controller 40 may perform overall control such that each component performs its function. The controller 40 may be implemented in the form of hardware or software, or may be implemented in a combination of hardware and software. Preferably, the controller 40 may be implemented as a microprocessor, but is not limited thereto.

The controller 40 may divide the dates into a specified number of classes based on traffic information by date for a preset time period stored in the storage 10, determine a target class corresponding to a target date (i.e., a date to be forecasted) among the classes, and predict the traffic flow of the target date based on the traffic information of each date included in the target class. In this case, the traffic information may include a traffic volume on each road, a traffic speed on each road, a travel time on each road, and the like. In addition, the road refers to a road where the entry and exit of vehicles is monitored, such as a highway, a toll road, or the like.

In this case, the controller 40 may divide the dates for a preset time period into classes such as an one-day public holiday that is not a weekend (Saturday and Sunday), a day before the one-day public holiday that is not a weekend, a day after the one-day public holiday that is not a weekend, a day before two consecutive public holidays, a first day of two consecutive public holidays, a last day of two consecutive days of public holidays, a day after two consecutive days of public holidays, a day before five consecutive days of public holidays, a first day of five consecutive days of public holidays, a last day of five consecutive days of public holidays, a day after five consecutive days of public holidays, a weekday, or the like.

In addition, the controller 40 may obtain current traffic information of the target date from the traffic information server 200 through the communication device 20 and forecast a future traffic flow of the target date based on the traffic information by date included in the target class and the current traffic information of the target date. In this case, the current traffic information of the target date refers to a traffic information of the target date stored in the traffic information server 200.

Meanwhile, the controller 40 may divide the dates into a specified number of classes for the morning traffic information and afternoon traffic information by date for the preset time period stored in the storage 10, determine a target class corresponding to a target date among the classes, and forecast the afternoon traffic flow of the target date based on the morning traffic information by date included in the target class and the morning traffic information of the target date. In this case, the controller 40 may obtain the morning traffic information of the target date from the traffic information server 200.

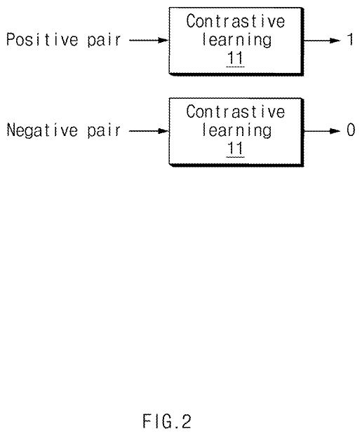

In this case, the controller 40 may determine a representative date most similar to the morning traffic information of the target date among the morning traffic information by date included in the target class, and forecast an afternoon traffic flow of the target date based on afternoon traffic information of the representative date. In this case, as shown in FIG. 2, the controller 40 may determine the representative date most similar to the morning traffic information of the target date among the morning traffic information by date included in the target class based on a contrastive learning model.

FIG. 2 is a diagram illustrating an example of a contrastive learning model provided in an apparatus for forecasting a traffic flow of a road.

As shown in FIG. 2, a contrastive learning model 11, which is an artificial neural network model that outputs the similarity (i.e., probability of being similar) between two samples, may be trained to output ‘1’ for two samples (positive pair) that are similar to each other, and to output ‘0 (zero)’ for two different samples (negative pair), thereby determining the similarity between the two samples.

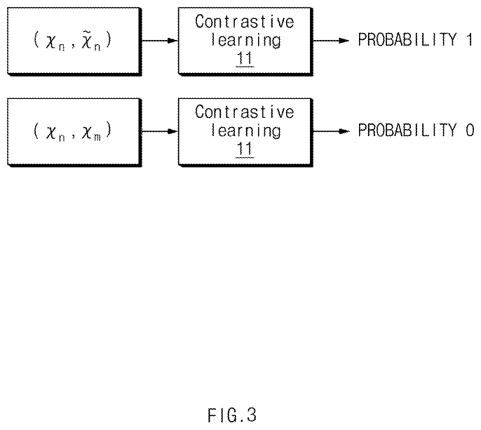

FIG. 3 is a diagram illustrating an example of a learning process of a contrastive learning model provided in an apparatus for forecasting a traffic flow of a road.

As shown in FIG. 3, the controller 40 may input two similar samples (xₙ,\tilde{x}ₙ) to the contrastive learning model 11 and train the contrastive learning model 11 to output a probability of ‘1’. In addition, the controller 40 may input two samples (xₙ,xₘ) that are not similar to each other into the contrastive learning model 11, and train the contrastive learning model 11 to output a probability of ‘0 (zero)’.

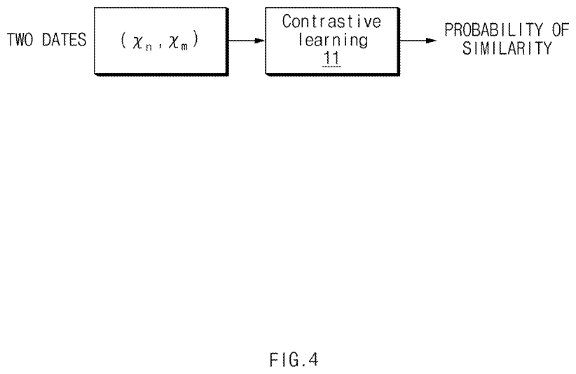

FIG. 4 is a diagram illustrating an example of a similarity prediction process of a contrastive learning model provided in an apparatus for forecasting a traffic flow of a road.

As shown in FIG. 4, the controller 40 may predict the similarity between two samples based on the contrastive learning model 11 that has completed learning. That is, the controller 40 may input morning traffic information by date included in the target class and morning traffic information of a target date into the contrastive learning model 11.

For example, when it is assumed that the morning traffic information by date included in the target class is A, B and C, and the morning traffic information of the target date is D, the controller 40 may obtain three similarities by sequentially inputting a total of three pairs (A-D, B-D, and C-D) into the contrastive learning model 11. In this case, the contrastive learning model 11 may predict the similarity between A and D by comparing A and D, predict the similarity between B and D by comparing B and D, and predict the similarity between C and D by comparing C and D.

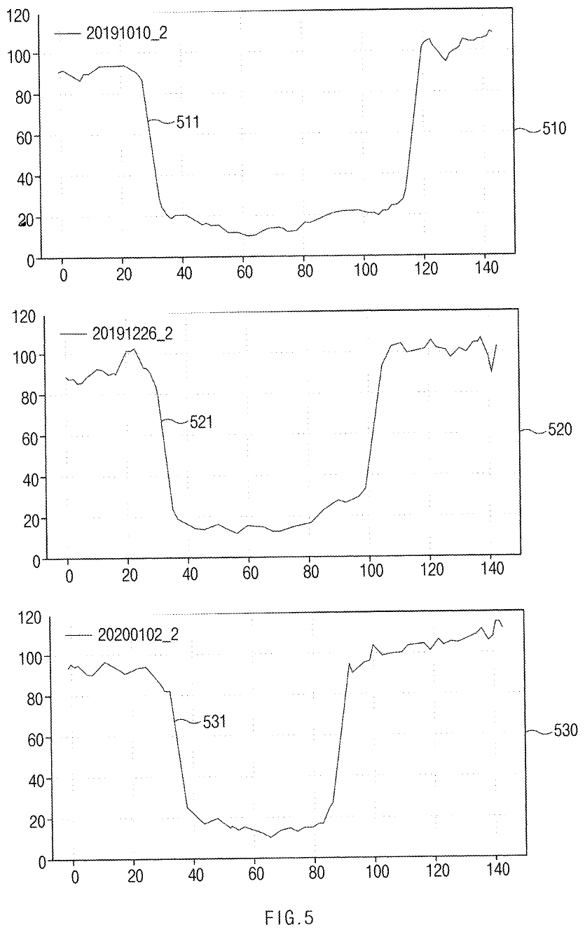

FIG. 5 is a diagram illustrating an example of traffic information by date of a first class stored in storage provided in an apparatus for forecasting a traffic flow of a road. FIG. 5 illustrates traffic speeds among the traffic information.

In FIG. 5, reference numeral 510 represents the afternoon traffic speed on a first road on Oct. 10, 2019, reference numeral 520 represents the afternoon traffic speed on the first road on Dec. 26, 2019, and reference numeral 530 represents the afternoon traffic speed on the first road on Jan. 2, 2020. In this case, the first class refers to the day after a one-day public holiday rather than a weekend, and includes Oct. 10, 2019, Dec. 26, 2019, and Jan. 2, 2020.

As shown in FIG. 5, because the traffic speed patterns 511, 521, and 531 included in the first class are similar to each other, it may be understood that the traffic speed patterns 511, 521 and 531 are well matched with each other depending on the nature of the first class.

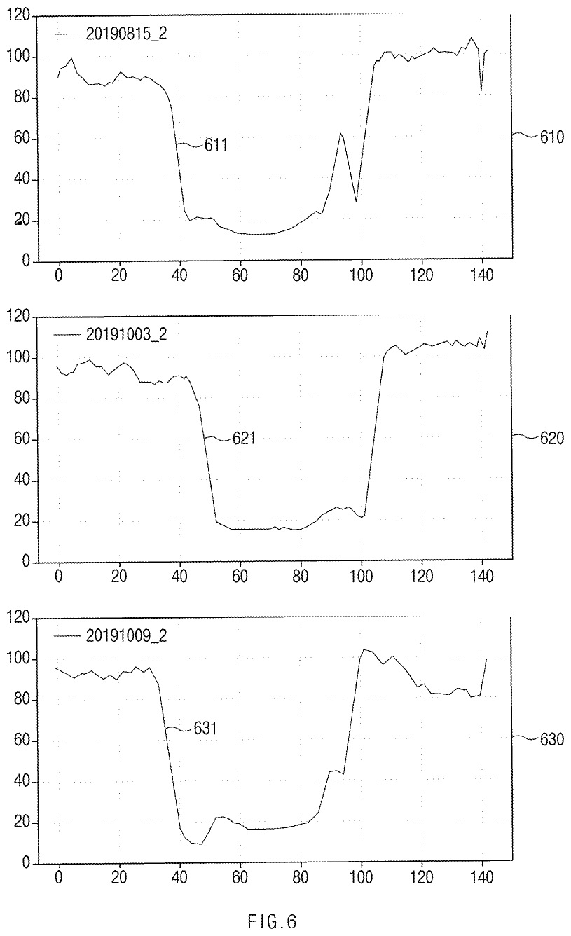

FIG. 6 is a diagram illustrating an example of traffic information by date of the second class stored in the storage provided in an apparatus for forecasting a traffic flow of a road, and illustrates the traffic speed among the traffic information.

In FIG. 6, reference numeral 610 represents the afternoon traffic speed on the first road on Aug. 15, 2019, reference numeral 620 represents the afternoon traffic speed on the first road on Oct. 3, 2019, and reference numeral 630 represents the afternoon traffic speed on the first road on Oct. 9, 2019. In this case, the second class refers to a one-day public holiday rather than a weekend, and includes Aug. 15, 2019, Oct. 3, 2019, and Oct. 9, 2019.

As shown in FIG. 6, because the traffic speed patterns 611, 621, and 631 included in the second class are similar to each other, it may be understood that the traffic speed patterns 611, 621, and 631 are well matched with each other depending on the nature of the second class.

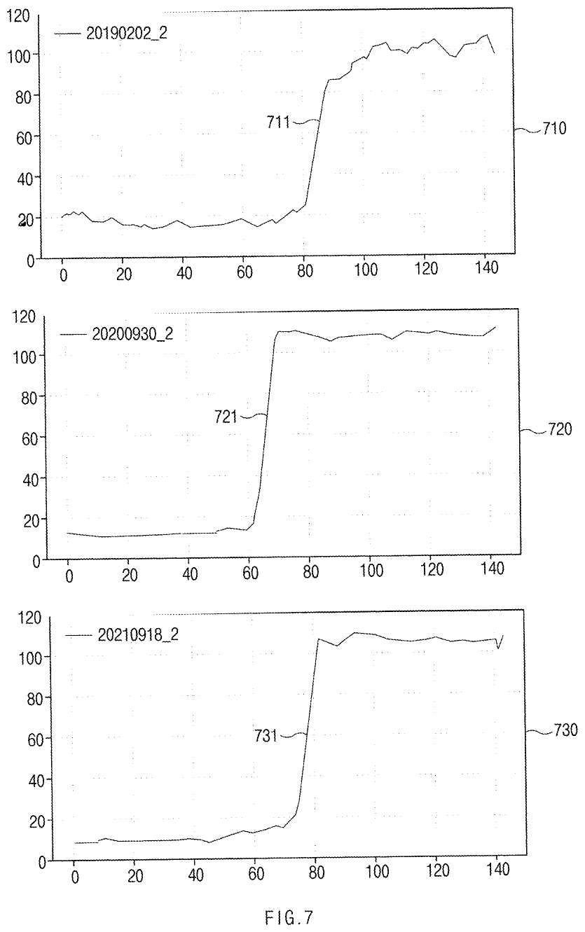

FIG. 7 is a diagram illustrating an example of traffic information by date of the third class stored in the storage provided in an apparatus for forecasting a traffic flow of a road, and illustrates the traffic speed among the traffic information.

In FIG. 7, reference numeral 710 represents the afternoon traffic speed of the second road on Feb. 2, 2019, reference numeral 720 represents the afternoon traffic speed of the second road on Sep. 30, 2020, and reference numeral 730 represents the afternoon traffic speed on the second road on Sep. 18, 2021. In this case, the third class refers to the first day of five consecutive public holidays, and includes Feb. 2, 2019, Sep. 30, 2019, and Sep. 18, 2021.

As shown in FIG. 7, because the traffic speed patterns 711, 721, and 731 included in the third class are similar to each other, it may be understood that the traffic speed patterns 711, 721, and 731 are well matched with each other depending on the nature of the third class.

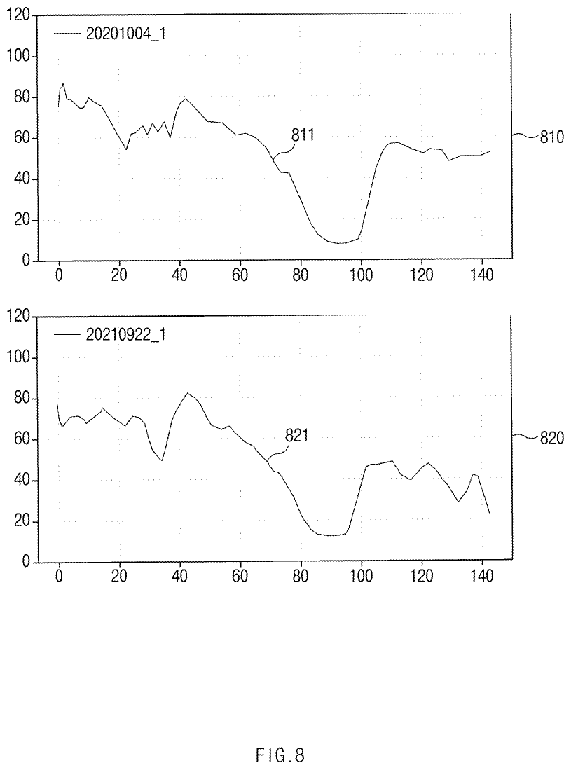

FIG. 8 is a diagram illustrating an example of traffic information by date of the fourth class stored in the storage provided in an apparatus for forecasting a traffic flow of a road, and illustrates the traffic speed among the traffic information.

In FIG. 8, reference numeral 810 represents the morning traffic speed of the third road on Oct. 4, 2020, and reference numeral 820 represents the morning traffic speed of the third road on Sep. 22, 2021. In this case, the fourth class refers to the last day of five consecutive public holidays, and includes Oct. 4, 2020 and Sep. 22, 2021.

As shown in FIG. 8, because the traffic speed patterns 811 and 821 included in the fourth class are similar to each other, it may be understood that the traffic speed patterns 811 and 821 are well matched with each other depending on the nature of the fourth class.

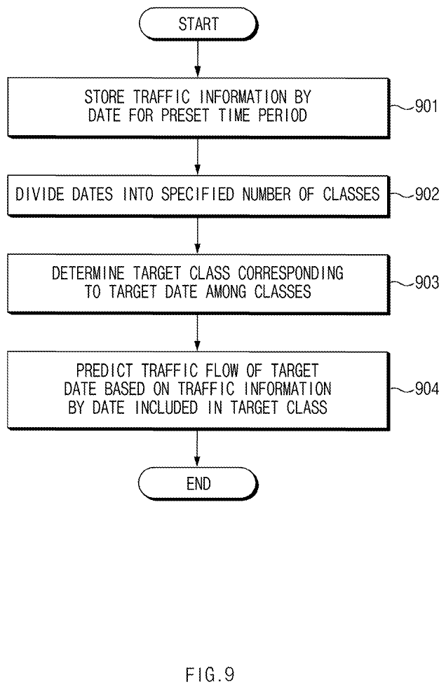

FIG. 9 is a flowchart illustrating a method of forecasting a traffic flow of a road.

First, in 901, the storage 10 stores the traffic information by date for the preset time period.

Then, in 902, the controller 40 divides the dates into the specified number of classes.

Then, in 903, the controller 40 determines a target class corresponding to the target date among the classes.

Then, in 904, the controller 40 predicts the traffic flow of the target date based on the traffic information by date included in the target class.

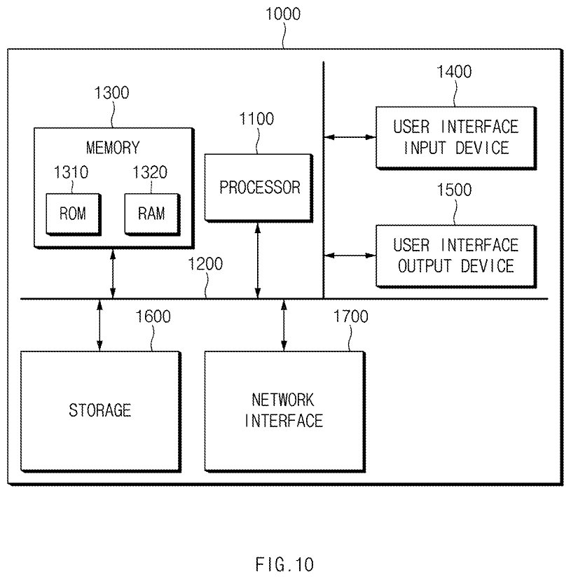

FIG. 10 is a block diagram illustrating a computing system for executing a method of forecasting a traffic flow of a road.

Referring to FIG. 10, a method of forecasting a traffic flow of a road described above may be implemented through a computing system 1000. The computing system 1000 may include at least one processor 1100, a memory 1300, a user interface input device 1400, a user interface output device 1500, storage 1600, and a network interface 1700 connected through a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the implementations of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor and the storage medium may reside in the user terminal as an individual component.

According to the implementations of the present disclosure, it is possible to forecast the traffic flow of the target date with high accuracy by storing traffic information by date for a preset time period, dividing dates into a specified number of classes, determining a target class corresponding to a target date among the classes, and forecasting a traffic flow of the target date based on the traffic information by date included in the target class.

What is claimed is:

1. An apparatus for forecasting a traffic flow of a road, the apparatus comprising:
storage configured to store traffic information categorized by predetermined dates; and
a controller configured to:
divide the dates into a specified number of classes,
determine a target class corresponding to a target date among the classes, and
determine a traffic flow of the target date based on information associated with one or more dates included in the target class within the traffic information.

2. The apparatus of claim 1, wherein the controller is configured to:
receive, from a traffic information server, traffic information of the target date, and
determine a future traffic flow of the target date based on traffic information associated with the one or more dates included in the target class and the traffic information of the target date.

3. The apparatus of claim 1, wherein the storage is configured to store morning traffic information and afternoon traffic information categorized by the predetermined dates.

4. The apparatus of claim 3, wherein the controller is configured to:
receive, from a traffic information server, morning traffic information of the target date, and
determine an afternoon traffic flow of the target date based on information associated with the one or more dates included in the target class within the morning traffic information and the morning traffic information of the target date.

5. The apparatus of claim 3, wherein the controller is configured to:
receive, from a traffic information server, morning traffic information of the target date,
determine a representative date from the one or more dates included in the target class, the representative date being associated with information that is most similar to the morning traffic information of the target date among morning traffic information associated with the one or more dates included in the target class, and
determine an afternoon traffic flow of the target date based on afternoon traffic information of the representative date.

6. The apparatus of claim 5, wherein the controller is configured to determine the representative date based on a contrastive learning model.

7. The apparatus of claim 1, wherein the traffic information includes at least one of a traffic volume on each road, a traffic speed on each road, or a travel time on each road.

8. The apparatus of claim 1, wherein the class includes at least one of an one-day public holiday that is not a weekend, a day before the one-day public holiday that is not a weekend, a day after the one-day public holiday that is not a weekend, a day before two consecutive public holidays, a first day of two consecutive public holidays, a last day of two consecutive days of public holidays, a day after two consecutive days of public holidays, a day before five consecutive days of public holidays, a first day of five consecutive days of public holidays, a last day of five consecutive days of public holidays, a day after five consecutive days of public holidays, or a weekday.

9. A method of forecasting traffic flow of a road, the method comprising:
storing, by storage, traffic information categorized by predetermined dates;
dividing, by a controller, the dates into a specified number of classes;
determining, by the controller, a target class corresponding to a target date among the classes; and
determining, by the controller, a traffic flow of the target date based on information associated with one or more dates included in the target class within the traffic information.

10. The method of claim 9, wherein determining the traffic flow of the target date includes:
receiving, by the controller, traffic information of the target date from a traffic information server; and
determining, by the controller, a future traffic flow of the target date based on traffic information associated with the one or more dates included in the target class and the traffic information of the target date.

11. The method of claim 9, wherein storing of the traffic information includes:
storing, by the storage, morning traffic information and afternoon traffic information categorized by the predetermined dates.

12. The method of claim 11, wherein determining the traffic flow of the target date includes:
receiving, by the controller, morning traffic information of the target date from a traffic information server; and
determining, by the controller, an afternoon traffic flow of the target date based on information associated with the one or more dates included in the target class within the morning traffic information and the morning traffic information of the target date.

13. The method of claim 11, wherein determining the traffic flow of the target date includes:
receiving, by the controller, morning traffic information of the target date from a traffic information server;
determining, by the controller, a representative date from the one or more dates included in the target class, the representative date being associated with information that is most similar to the morning traffic information of the target date among morning traffic information associated with the one or more dates included in the target class; and
determining, by the controller, an afternoon traffic flow of the target date based on afternoon traffic information of the representative date.

14. The method of claim 13, wherein determining the representative date includes:
determining, by the controller, the representative date based on a contrastive learning model.

15. The method of claim 9, wherein the traffic information includes at least one of a traffic volume on each road, a traffic speed on each road, or a travel time on each road.

16. The method of claim 9, wherein the class includes at least one of an one-day public holiday that is not a weekend, a day before the one-day public holiday that is not a weekend, a day after the one-day public holiday that is not a weekend, a day before two consecutive public holidays, a first day of two consecutive public holidays, a last day of two consecutive days of public holidays, a day after two consecutive days of public holidays, a day before five consecutive days of public holidays, a first day of five consecutive days of public holidays, a last day of five consecutive days of public holidays, a day after five consecutive days of public holidays, or a weekday.
